(19) United States
(12) Patent Application Publication
(10) Pub. No.: US 2013/0334121 A1
(43) Pub. Date: Dec. 19, 2013

(54) WATER PURIFYING DEVICE

(71) Applicant: Ying-Chi CHEN, Taichung City (TW)

(72) Inventor: Ying-Chi CHEN, Taichung City (TW)

(21) Appl. No.: 13/918,417

(22) Filed: Jun. 14, 2013

(30) Foreign Application Priority Data
Jun. 15, 2012 (TW) 101121575

(51) Int. Cl. C02F 1/00

(52) U.S. Cl. CPC C02F 1/002
USPC 210/244; 210/473; 210/321.6; 210/295

(57) ABSTRACT

A water purification device includes a container, at least a filtration unit, and a trailing cable connected to the container or the filtration unit. The container has therein a chamber and at least a first opening in communication with the chamber. The filtration unit is disposed in the first opening to admit sewer water and thus remove most impurities therefrom. Accordingly, the water purification device sinks spontaneously into the sewer water to be filtered so as, to filter the external sewer water by means of water pressure and thus produce drinking water.

### BACKGROUND OF THE INVENTION

1. Technical Field

The present invention relates to water treatment apparatuses defined by IPC, C02F, and more particularly, to a water purification device which is easy to use and portable.

2. Description of Related Art

Water is one of the most valuable resources available on the Earth. Drinking water is required for the survival of human beings. To obtain clean drinking water, conventional water purification processes usually entail filtering impurities and bacteria out of sewer water by distillation and filtration. Distillation apparatuses are so bulky that their use is restricted to distilled water manufacturers. By contrast, households usually resort to filtration-based water purification technology. One of the prerequisites for filtration-based water purification technology is applying a specific operating pressure, whether by hand, by electric power, or by a pressurization apparatus, such as a water tower, so that, under the operating pressure, sewer water to be filtered passes through a filter cartridge of a water purification device and produces clean drinking water.

The pressurization apparatus adds to the volume of the water purification device; as a result, the water purification device is hardly portable outdoors or at sea. In view of this, a water purification device manufacturer develops a water purification apparatus which is pressurized directly by hand. However, a manually pressurizing pump is not only structurally intricate but also susceptible to damage caused by a loosened screw or a severed lever, thereby lacking ease of use.

Another conventional water purification device comprises a stainless steel pipe which is 1.5 to 4 meters long. A user dips the stainless steel pipe into water so that water passes through a reverse osmosis membrane (RO membrane) under the water pressure inside the pipe and by means of a funnel pressurizer positioned at the pipe bottom to undergo filtration and thus produce drinking water. Although the conventional water purification device does not consume additional energy, users find its long stainless steel pipe inconvenient to carry. Another drawback of the conventional water purification device is that the water pressure inside the pipe depends on the length of the pipe. A conventional water pressure calculation rule sets forth a water pressure of 1 Kg/cm² at a depth of 10 meters approximately. Hence, a 1.5 m stainless steel pipe generates a maximum water pressure of 0.15 Kg/cm² approximately, which is insufficient to enable the RO membrane to function efficiently. If the pipe is lengthened, the pipe will become overly bulky and heavy. Furthermore, if the water purification device is not equipped with a support, the user will have to grip the pipe by hand in order to submerge the pipe in water for 10 to 30 minutes laboriously, thereby posing a threat to the health or even safety of the user outdoors or at sea. In consideration of its aforesaid drawbacks, the conventional manually-operated water purification device is neither practical nor convenient to use.

### SUMMARY OF THE INVENTION

In view of this, the objective of the present invention is to provide a water purification device which utilizes the pressure of sewer water as the pressure source to enable the filtration function with portability and ease of use.

In order to achieve the above and other objectives, the present invention provides a water purification device capable of sinking spontaneously into sewer water to be filtered, comprising: a container having therein a chamber and at least a first opening in communication with the chamber; at least a filtration unit disposed in the first opening and adapted to admit the sewer water to be filtered and remove most impurities The filtrate then flows to and is stored in the chamber. And a trailing cable with an end connected to the container or the filtration unit.

Hence, the water purification device filters external sewer water to produce drinking water for users, utilizing natural water pressure and dispensing with any additional apparatus for pressurizing water.

Preferably, the filtration unit is a composite structure integrally formed as a unitary structure. For example, the filtration unit comprises a filter cartridge and an external shell enclosing the filter cartridge. The external shell has multiple inlet holes allowing water from outside to the filter cartridge. There is an inlet allows the filter cartridge to communicate with the chamber.

Preferably, the container comprises a body and a first lid. The body has a second opening coupled to the first lid. Furthermore, the first opening and the filtration unit are selectively disposed at the first lid or at the first opening of the body. Hence, the user can open the container quickly by means of the first lid.

Preferably, the filtration unit comprises RO membrane for removing most of the salt and impurities out of seawater.

Preferably, the container is made of plastic material, and the container is provided therein with at least a supporting slat whereby the container is prevented from compression and deformation which might otherwise occur when the container is submerged in sewer water and thus subjected to water pressure therefrom. Furthermore, a heavy object can be hung from the water purification device to increase its weight.

Accordingly, the water purification device of the present invention is structurally simple, insusceptible to damage, and easy to use. The water purification device starts producing drinking water as soon as a user immerses the water purification device in water. After a short while users can then pull it out and drinking water is available. Furthermore, the water purification device is capable of diversity and thus meeting user needs, that is, ease of use and portability. Last but not least, the water purification device is practical.

### BRIEF DESCRIPTION OF THE SEVERAL VIEWS OF THE DRAWINGS

FIG. 1 is a schematic view of a water purification device according to the first preferred embodiment of the present invention;

FIG. 2 is a schematic view of the water purification device according to the second preferred embodiment of the present invention; and

FIG. 3 is a schematic exploded view of the water purification device according to the third preferred embodiment of the present invention.

### DETAILED DESCRIPTION OF THE EMBODIMENTS OF THE INVENTION

The present invention is hereunder described and illustrated with preferred embodiments and drawings. Words, such as “internal” and “external”, which are indicative of directions, are comprehensible to laymen in terms of their understanding of a water container. Like elements in the embodiments are denoted with like reference numerals to facilitate the identification thereof.

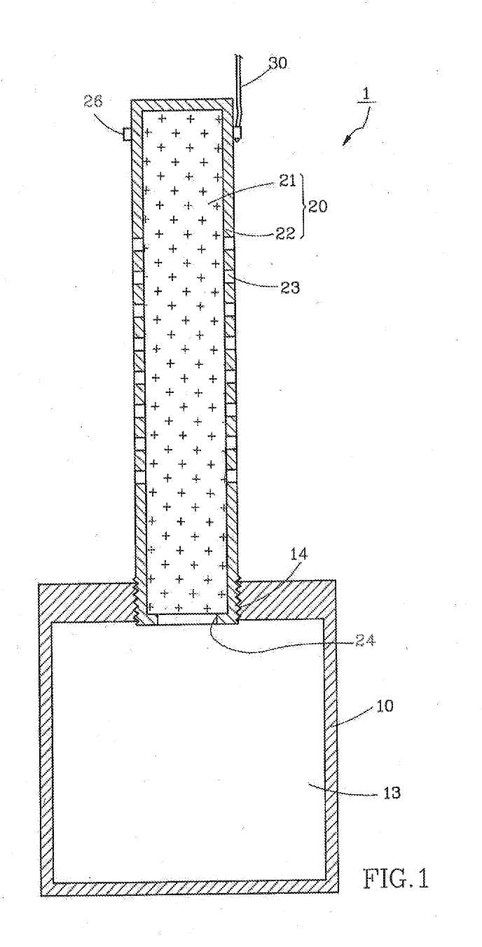

Referring to FIG. 1, in the first embodiment of the present invention, a water purification device 1 comprises a container 10, a filtration unit 20 disposed on the external surface of the container 10, and a trailing cable 30 connected to one end of the filtration unit 20.

The container 10 has therein a chamber 13 and a first opening 14 in communication with the chamber 13. The first opening 14 is a screw hole. The container 10 is made of a metal, such as stainless steel, and is a cylindrical container which is 11 cm in diameter, 13.7 cm in height, with the thickness of 0.5 cm, and with an internal capacity of 1000 ml. The container 10 has a specific gravity of 1.76 g/cm³ approximately and thus is heavy enough to sink into the sea spontaneously(sea water has a density of 1.0278 g/cm³ approximately at 3.98° C.)

In this embodiment, the filtration unit 20, which is a composite structure integrally formed as a unitary structure, is internally provided with a filter cartridge 21 made from a porous material and externally provided with an external shell 22 made of a polymer, such as ABS resin. One end of the filtration unit 20 is threaded and thus screwed to the first opening 14 of the container 10. A plurality of inlet holes 23 is disposed at the shell 22 to enable the filter cartridge 21 to communicate with the outside. An inlet 24 is disposed at the external shell 22 to enable the filter cartridge 21 to communicate with the chamber 13.

Furthermore, a connection portion 26 is disposed on a lateral side of the filtration unit 20 and positioned distal to the container 10. One end of the trailing cable 30 is fastened to the connection portion 26.

Hence, a user either grips the trailing cable 30 by hand or fastens one end of the trailing cable 30 to a specific place. Then, the user lowers the container 10 and the filtration unit 20 together into sewer water to be filtered, such that the container 10 and the filtration unit 20 sink. The water pressure exerted on the filtration unit 20 increases with the depth of the submerged filtration unit 20. As soon as the difference between the water pressure exerted on the filtration unit 20 and the internal gas pressure of the chamber 13 exceeds the predetermined operating pressure of the filtration unit 20, the sewer water to be filtered begins to pass through the filtration unit 20 to remove most of the salt, impurities, and bacteria. The filtrate passes through the inlet 24 to enter the chamber 13 and thus is stored therein.

In this embodiment, the composite structure of the filtration unit 20 merely serves an illustrative purpose, as persons skilled in the art may replace the composite structure of the filtration unit 20 with any other multilevel structure when needed. For example, by covering the filter cartridge with a RO membrane or changing the materials of which the filter cartridge and the external shell are made. The aforesaid replacement and change is regarded as a simple variation of the water purification device of the present invention as well as an equivalent structure change thereto.

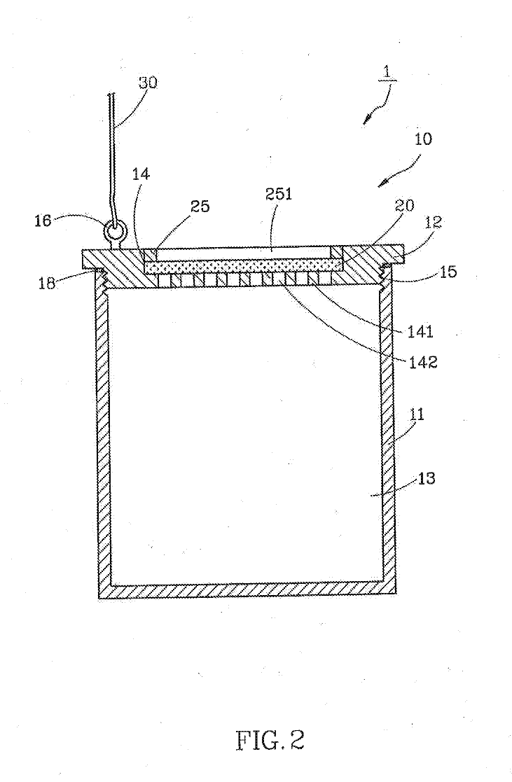

With the aforesaid design concept, in the second embodiment of the present invention as shown in FIG. 2, the water purification device 1 comprises a container 10 and a filtration unit 20 disposed on the external surface of the container 10. The second embodiment is distinguished from the first embodiment by structural features described as follows:

The container 10 comprises a body 11 and a first lid 12 coupled together. The body 11 has a second opening 15. The first lid 12 is screwed to the second opening 15 to cover it. An O-ring 18 is disposed between the first lid 12 and the body 11 and adapted to enhance the waterproof feature thereof Furthermore, the first opening 14 of the container 10 is formed at the first lid 12. The first opening 14 has therein a supporting board 141 and a plurality of inlets 142 formed to penetrate the supporting board 141. A connection portion 16 is disposed at the first lid 12, exemplified by a hanging ring in this embodiment, and adapted to connect with the trailing cable 30.

In this embodiment, the filtration unit 20 is a RO membrane disposed on the supporting board 141 of the first opening 14. One side of the filtration unit 20 is covered with a second lid 25 positioned distal to the supporting board 141. A inlet hole 251 is formed to penetrate the second lid 25. Alternatively, the inlet hole 251 is provided in plurality.

In both the second embodiment and the first embodiment, the container 10 has an internal capacity of 1000 ml. When the container 10 is submerged at a depth of 10 m, it brings about a pressure difference of 1 Kg/cm²; at this point in time, the container 10 has an internal air pressure of 1 atm approximately (about 1 Kg/cm²) and an external water pressure which amounts to the sum of 1 atm and 1 Kg/cm².

If the volume of the water accumulated in the container 10 reaches 100 ml, the internal pressure of the container 10 will equal the sum of 1 atm and 0.11 Kg/cm². Furthermore, if the volume of the water accumulated in the container 10 reaches 200 ml, the internal pressure of the container 10 will equal the sum of 1 atm and 0.25 Kg/cm². If the volume of the water accumulated in the container 10 reaches 500 ml, the volume of the air inside the container 10 will reduce to 500 ml, such that the internal pressure of the container 10 will equal the sum of 1 atm and 1 Kg/cm²; meanwhile, the internal pressure and external pressure of the container 10 are substantially equal, and thus water will no longer flow into the container 10.

As regards the operating pressure of the filtration unit 20 (RO membrane), the commercially available Toray TMG20-370 RO membrane has an optimal operating pressure of 10 psi (about 0.7 Kg/cm²) at which the round RO membrane of a diameter of 10 cm produces 10 ml of clean water per minute. To increase the clean water yield, it is feasible to increase pressure, that is, by lowering the water purification device 1 immersed in sewer water to a depth of 20 to 30 meters.

After filtration has taken place for 20 minutes approximately, the user pulls the container 10 out of the sewer water. After removing the first lid 12, the user fetches about 200 ml of the filtrate which is sufficient to alleviate the user's thirst. By repeating the aforesaid process several times, the filtrate thus fetched is sufficient to cater to several users' drinking need. As regards the replacement of the filtration unit 20, the user removes the second lid 25 and changes the filtration unit 20.

Therefore, the present invention is characterized in that: the intrinsic water pressure of the sewer water to be filtered functions as the pressure source for use in filtration; once the user puts the water purification device in the sewer water, the water purification device will sink until it reaches a sufficient depth; hence, the filtration process is not laborious; furthermore, the water purification device is structurally simple, compact, and portable.

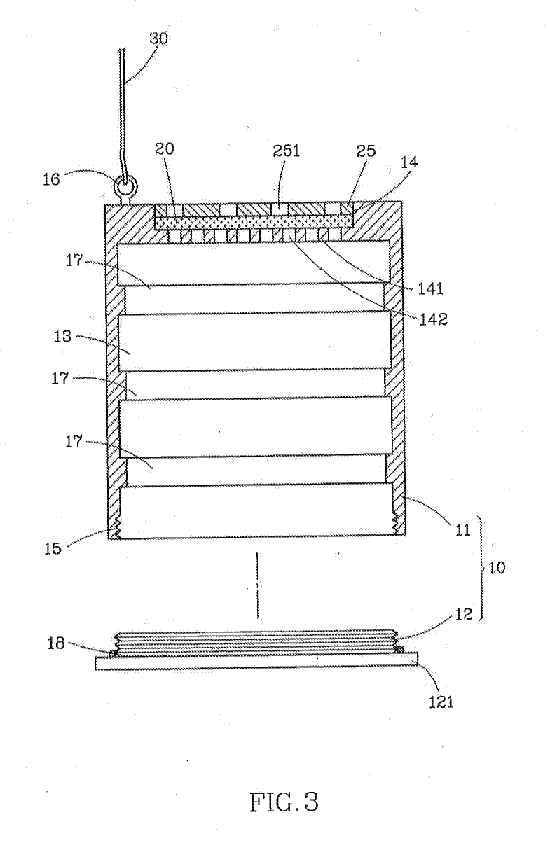

Referring to FIG. 3, the third embodiment of the present invention is similar to the second embodiment of the present invention in that a water purification device 1 comprises a container 10, a filtration unit 20 disposed on the external surface of the container 10, and a trailing cable 30 connected to one end of the container 10. The third embodiment is distinguished from the second embodiment by structural features described below.

The container 10 is made of a material of a low density, such as a plastic. The inner wall of the body 11 is provided with a plurality of supporting slats 17 whereby the container 10 is prevented from serious deformation which might otherwise occur when the container 10 is compressed under the external water pressure. Furthermore, the water purification device 1 further comprises a weight (not shown) which hangs at the container 10, the connection portion 16, the trailing cable 30, or any appropriate point to increase the specific gravity of the water purification device 1, such that the water purification device 1 has a larger specific gravity than the sewer water to be filtered. The weight is a metallic block, a piece of stone, or a net bag which contains a heavy object.

Furthermore, the first opening 14, the supporting board 141, the filtration unit 20, and the second lid 25 are disposed on the body 11 of the container 10. The first lid 12 is provided in a one-piece manner. The first lid 12 extends outward to form a flange 121. An O-ring 18 is disposed between the flange 121 and the end portion of the body 11 to enhance the waterproof feature thereof.

Due to the aforesaid structures, the intrinsic water pressure of the sewer water to be filtered functions as the pressure source for use in filtration, and, upon completion of the filtration process, the user can loosen the first lid 12 and open the container 10 quickly to take the clean water from the chamber 13 conveniently.

The filtration unit of the water purification device of the present invention is not necessarily provided in singularity. Alternatively, the container may have a plurality of first openings operating in conjunction with a plurality of filtration units. In addition, it is also feasible that the first lid 12 and the second lid 25 of the container 10 are coupled thereto by any means other than screwing, for example, by a coupling ring or by high-frequency welding.

In conclusion, the water purification device of the present invention is characterized in that: the intrinsic water pressure of sewer water to be filtered functions as the pressure source for use in filtration; the sewer water outside the container is filtered to produce clean water, without the use of electric power or the user's labor; the water purification device is structurally simple, compact, easy to carry by the user, and easy to be installed on a ship; and, to meet their drinking water need, the users put the water purification device into seawater or the water at a lake to produce clean drinking water.

The present invention is disclosed above by preferred embodiments. However, equivalent structural changes made to the preferred embodiments in accordance with the specification and the claims should fall into the scope of the claims of the present invention.
water purification device 1
container 10
body 11
first lid 12
flange 121
chamber 13
first opening 14
supporting board 141
inlet 142
second opening 15
connection portion 16
supporting slat 17
O-ring 18
filtration unit 20
filter cartridge 21
external shell 22
inlet holes 23
inlet 24
second lid 25
inlet holes 251
connection portion 26
trailing cable 30

What is claimed is:

1. A water purification device capable of sinking into sewer water to be filtered, comprising:
a container having therein a chamber and at least a first opening in communication with the chamber;
at least a filtration unit disposed in the first opening and adapted to admit the sewer water to be filtered and remove most of impurities out of the sewer water to be filtered, such that a filtrate is delivered to and stored in the chamber; and
a trailing cable with an end connected to one of the container and the filtration unit.

2. The water purification device of claim 1, wherein the container comprises a body and a first lid, and the body has a second opening coupled to the first lid.

3. The water purification device of claim 1, wherein the filtration unit comprises a reverse osmosis membrane

4. The water purification device of claim 1, wherein the filtration unit is a composite structure integrally formed.

5. The water purification device of claim 4, wherein the filtration unit comprises a filter cartridge and an external shell enclosing the filter cartridge, the external shell having a plurality of inlet holes and an inlet, the plurality of feeding pores allowing the filter cartridge to communicate with an outside, and the inlet allowing the filter cartridge to communicate with the chamber.

6. The water purification device of claim 4, wherein the filtration unit is screwed to the first opening.

7. The water purification device of claim 1, wherein the filtration unit comprises a filter cartridge and a RO membrane which together feature a multilevel structure.

8. The water purification device of claim 1, wherein the first opening has therein a supporting board and a plurality of inlet holes formed to penetrate the supporting board, the filtration unit being disposed on the supporting board, and a side of the filtration unit is covered with a second lid positioned distal to the supporting board, wherein at least a inlet hole is formed to penetrate the second lid.

9. The water purification device of claim 2, wherein the first opening is disposed at the first lid and has therein a supporting board and a plurality of inlet holes fanned to penetrate the supporting board, the filtration unit being disposed on the supporting board, and a side of the filtration unit is covered with a second lid positioned distal to the supporting board, wherein at least a inlet hole is formed to penetrate the second lid.

10. The water purification device of claim 2, wherein the first lid extends outward to form a flange, and an O-ring is disposed between the flange and the body.

11. The water purification device of claim 1, wherein the container is made of a plastic and provided therein with at least a supporting slat.

12. The water purification device of claim 11, wherein the water purification device comprises at least a weight.
